(19) United States
(12) Patent Application Publication
(10) Pub. No.: US 2005/0069110 A1
(43) Pub. Date: Mar. 31, 2005

(54) Phone access to stored list of authorization codes and gateway functions

(76) Inventors: Bart D. Stanco, Fairfield, CT (US); Shlomo Shur, Fairfield, CT (US); Andrew Kontomerkos, Trumbull, CT (US)

Correspondence Address: BACHMAN & LAPOINTE, P.C., 900 CHAPEL STREET, SUITE 1201, NEW HAVEN, CT, 06510, US

(21) Appl. No.: 10/916,793

(22) Filed: Aug. 11, 2004

Related U.S. Application Data
(60) Provisional application No. 60/494,140, filed on Aug. 11, 2003.

(51) Int. Cl. H04M 15/00

(52) U.S. Cl. 379/114.01; 379/114.14

(57) ABSTRACT

A method for communicating a telephone with a source of authorization codes, access codes and gateway functions, including the steps of communicating a telephone with a source of security code information; verifying that the telephone is authorized to access the source of security code information; and providing to the telephone a series of choices of service selections requiring the security code information.

### BACKGROUND OF THE INVENTION

The invention relates to phone communication and phone accessed services and, more particularly, to a system and method for facilitating phone access through authorization codes and the like to services such as gateway functions.

Phones are rapidly becoming a part of everyday life functions and, used properly, can greatly enhance and facilitate such functions. Often, phones are the only device available to an individual for accessing or communicating with other individuals and/or sources.

Numerous new and/or popular media sources are available which provide sources of news, entertainment and the like. Unfortunately, such services are sometimes difficult to access. For example, radio signals when accessed conventionally can be limited to certain areas and can be subject to various interference and/or interruption with the signal. Also, many of these services are subscriber only and thus require log in or sign in for access.

It is the object of the invention to both enhance the usefulness of phone devices and also to enhance access to such services as may be desired.

### SUMMARY OF THE INVENTION

According to the invention, the foregoing object is attained. According to the invention, a phone and server system are provided whereby the phone can be used to access authorization codes, access codes and the like, and/or services which may requires such codes, to allow easier access to various services by telephone. Examples of such services include international calling plans, radio services, and the like. According to the invention, a phone device is used and/or adapted to have ready access to required codes so that, upon implementing a call, the user can readily connect to the desired service.

### DETAILED DESCRIPTION

The goal is to allow quick and easy access to authorization codes, access codes and gateway to functions. As set forth above, one example of a service with which the present invention is advantageously used it to call from a cell phone to an international calling service that requires the caller to enter a user identification, password and account information before gatewaying or connecting into the international dialing services at reduced rates.

A person connects, for example by dialing a number, or using a pre-programmed feature key, browser interaction or a voice command, to the authorization codes and gateway functions from any phone. In addition, for example using browser interaction as indicated, the subscriber can use a browser to set up the access information and codes, and the browser can be via any device including the phone itself, a pc device and the like. The authorization codes and gateway functions application can be adapted to either automatically identify the caller, or the caller may be prompted to enter information such as identification code, billing information for new subscribers, offering code and the like.

Security and encryption may be used to store codes and also for automatic or manual access. Subscriber information can preferably be stored in a secure manner such as hashed assess for example. If the calling device supports biometric options such as finger printer reading, two-factor security can be implemented. In addition the device of the present invention can use server (network) based voice recognition for additional security if needed, for example for calls to unusual and/or out of profile calling of the system, for which the system can be programmed to automatically invoke additional security. The system will also have the capability to take actions if fraud or security concerns are detected. Such actions can include suspending the account, automatically route to intercept for reverse GPS or cell triangulation to locate the caller, and/or passing the caller to additional authorization for approval, among other actions. The additional level of authorization can be an automated process or via operator assisted transactions. Fraud can be detected via heuristic calling patterns; alerts issued by agency or service provider, the subscriber themselves (such as reporting a lost phone) and the like. The information can be submitted via computer, web, fax (ocr), profile characteristic, heuristic determination, third party alert etc., and this advantageously enhances the security with which the system and method of the present invention can be implemented.

Subscribers can be signed up to the authorization codes and gateway functions in various ways, including but not limited to the WEB, a third party agent or by connecting to the authorization codes and gateway functions server.

The subscriber can then chose which functions to access. The subscriber can access gateway functions using various methods as follows.

In one embodiment, a single digit or one or more voice commands can be entered which correspond to pre-selected authorization codes. The subscriber or a third party agent may configure the pre-selections. The pre-selection configuration can be administered over the WEB or via connection to the services server, or in other ways known to one of ordinary skill in the art.

The subscriber can dial or speak the authorization codes.

The subscriber can be automatically connected to pre-configured authorization codes and functions based on time of day, day of week or event trigger, which would be initiated by the subscriber phone.

The “authorization codes/gateway functions” can also be programmed to originate a connection to the subscriber based upon time of day, day of week or event trigger, for example.

The authorization codes/gateway functions can be delivered via a computer based server that can be and/or is connected to in any of the following methods, including connecting to third party applications; internet connection; bridging to a gateway server for sources of functions and services provided to subscribers and the like. The computer based authorization codes/gateway functions server can be the authentication server as well, or the process of authentication can be delegated to another server or computer based service. A web server component is also advantageously a part of the authorization codes/gateway functions. The web server component has several sub-functions that can be used or not, as necessary.

The web server component can be adapted to provide a registration process, authorization codes/gateway functions selection configuration for dialed digit access, alert status configuration tables (time of day, day of week, event trigger, etc). The web services component is also advantageously adapted to provide a data transfer mechanism that can be, for example, a billing system or system for transferring billing information to a third party.

The computer based authorization codes/gateway functions server can directly be the web server or the process of the web server can be delegated to another server or computer based service.

It should be appreciated that the present invention advantageously provides communication of a phone and services and/or access codes for services as desired, with the following advantageous features:

concept of connecting by phone (cell, land line, sea, or any device that can connect to the public voice network) to stored list of authorization codes and gateway functions;

auto and manual identification of subscriber;

gateway service server that can be and/or is connected to any of the following: connect to third party applications, internet connected, bridged to gateway server for sources of functions and services provided to subscribers;

single or multiple digit access to gateway and authorization codes services;

speech recognition access to authorization codes;

dial up call access to authorization codes;

event trigger access;

code based access;

alert and or automatic calls to subscriber based on profile such as time of day, day or week, or an event; and

web based self service access for configuration, provisioning and or billing.

It should be appreciated that the present invention therefore advantageously provides a phone user with easy and secure access to various phone accessible service such as radio services, international calling plans and the like through an access code identification process and a process for selection of desired services associated with same which greatly expand the conventional uses of the phone and facilitate enjoyment or other use of such services as desired.

It should also be understood that the invention is not limited to the illustrations described and shown herein, which are deemed to be merely illustrative of the best modes of carrying out the invention, and which are susceptible of modification of form, size, and arrangement of parts and details of operation. The invention rather is intended to encompass all such modifications which are within its spirit and scope.

1. A method for communicating a telephone with a source of authorization codes, access codes and gateway functions, comprising the steps of:
communicating a telephone with a source of security code information;
verifying that the telephone is authorized to access the source of security code information; and
providing to the telephone a series of choices of service selections requiring the security code information.
